(19) United States
(12) Patent Application Publication
(10) Pub. No.: US 2025/0114694 A1
(43) Pub. Date: Apr. 10, 2025

(54) ANALOG STICK WITH AN ECCENTRICALLY ARRANGED SPRING MOUNTING

(71) Applicant: Infineon Technology AG, Neubiberg (DE)

(72) Inventors: Jakob VALTL, München (DE); Stephan LEISENHEIMER, Oberhaching (DE)

(21) Appl. No.: 18/894,196

(22) Filed: Sep. 24, 2024

(30) Foreign Application Priority Data
Oct. 9, 2023 (DE) 102023209833.4

(51) Int. Cl. A63F 13/24; G05G 5/05; G05G 9/047

(52) U.S. Cl. CPC A63F 13/24; G05G 5/05; G05G 9/047; G05G 2009/04755; G05G 2009/04766; G05G 2505/00

(57) ABSTRACT

The innovative concept disclosed herein relates to an analog stick with a pivotably mounted operating lever having, on a first axial end portion, an operating element and, on an opposite second axial end portion, a plate-like actuating element. The plate-like actuating element is in contact with a spring-preloaded brace and is configured to transmit a deflection of the operating lever to the brace, as a result of which the brace is deflected counter to the spring force of the spring element. The brace is configured to restore the operating lever to its zero position in a non-actuated state using the spring force of the spring element, the spring element and the operating lever being laterally spaced apart from one another, as seen in an extent direction of the brace.

### CROSS-REFERENCE TO RELATED APPLICATION

This application claims priority to Germany Patent Application No. 102023209833.4 filed on Oct. 9, 2023, the content of which is incorporated by reference herein in its entirety.

### TECHNICAL FIELD

The innovative concept described herein relates to an analog stick for a joystick or game controller with magnetic field-based motion detection.

### BACKGROUND

Nowadays joysticks are used for control in many applications. Joysticks have become known in particular in connection with the control of computer games. In the meantime, however, industrial machines and aircraft are also controlled with joysticks.

Initially, in particular digital joysticks were widely used. These could be used, similarly to in the case of a directional pad, to digitally map four directions (left/right-up/down). However, with the advent of three-dimensional worlds in computer games, the demand on the control also became more complex. This led to the development of analog controllers or joysticks which could be used to map the movements much more precisely.

In the consumer market, these analog control devices have become known in particular through the introduction of analog sticks into game controllers. The analog sticks are usually installed in addition to a directional pad and are intended for operation with the thumbs. However, in principle, such analog sticks can also be used for analog motion transmission in joysticks and other control elements.

What is important here is the haptics for the user. In this case, it is desired that the analog stick delivers the same haptics in all movement ranges, as a result of which the analog stick always feels the same for the user in each position. Nowadays this is achieved by arranging a conventional steel spring below the analog stick. This steel spring is arranged centrally under the analog stick or concentrically with respect to the central axis of the analog stick, with the result that the spring force always proportionally counteracts a deflection of the analog stick. As a result, the deflection of the analog stick always feels the same for the user over the entire movement range thereof.

For the motion detection of the analog stick, use is in this case made of potentiometers which are attached laterally to the axles of the analog stick. However, a relatively large minimum installation space is required to accommodate the analog stick together with the laterally attached potentiometers. There is additionally also a pressure function of the analog stick, e.g., the user can also press down the analog stick in addition to the pivoting movement, in order to use it as a pushbutton. For this purpose, a further switch is required. However, this cannot be arranged below the analog stick since the spring is located here. Therefore, this switch must also likewise be attached laterally to the analog stick, this additionally increasing the installation space.

Magnetic sensors are a conceivable alternative for the motion detection of the analog stick. These deliver a highly precise resolution of the movement of the analog stick and are also inexpensive commercially. These are microelectronic components which have much smaller dimensions than potentiometers. However, magnetic field sensors manufactured in microelectronics are also very sensitive. The metal spring below the analog stick generates magnetic interference fields which significantly impair the measurements.

### SUMMARY

It would therefore be desirable to realize highly precise motion detection of analog sticks with the smallest possible installation space, and at the same time to provide haptics that are largely uniform over the entire movement range of the analog stick.

This aim is achieved using an analog stick as claimed in claim 1. Further implementations and advantageous aspects of this analog stick are specified in the respective dependent patent claims.

The innovative analog stick presented herein has an operating lever which can be pivotably deflected using two rotation axles arranged orthogonally with respect one another. On a first axial end portion, the operating lever has an operating element for moving the operating lever. On an opposite second axial end portion, the operating lever has a plate-like actuating element which is movable together with the operating lever. The analog stick also has a brace preloaded using a spring element, the plate-like actuating element being in contact with the brace and being configured to transmit a deflection of the operating lever to the brace, as a result of which the brace is deflected counter to the spring force of the spring element. The brace is configured to restore the operating lever to its zero position in a non-actuated state using the spring force of the spring element. The spring element and the operating lever are laterally spaced apart from one another, as seen in an extent direction of the brace. This makes it possible to save on the installation space below the analog stick, which is otherwise occupied by the spring in conventional analog sticks, resulting in new design possibilities.

### BRIEF DESCRIPTION OF THE DRAWINGS

A few example implementations are illustrated by way of example in the drawing and explained below. In the figures:

FIG. 1 shows a schematic partially transparent side view of an analog stick according to an example implementation,

FIG. 2 shows a schematic partially transparent perspective view of an analog stick according to an example implementation,

FIG. 3A shows a schematic perspective view of a brace and of a plate-like actuating element for deflecting the brace according to an example implementation,

FIG. 3B shows a schematic partially transparent perspective view of an analog stick with a brace and a plate-like actuating element for deflecting the brace according to an example implementation,

FIG. 4A shows a schematic partially transparent perspective view of a deflected analog stick according to an example implementation,

FIG. 4B shows a schematic partially transparent side view of an analog stick deflected in a first direction according to an example implementation,

FIG. 4C shows a schematic partially transparent side view of an analog stick deflected in an opposite second direction according to an example implementation,

FIG. 5A shows a schematic bottom view of a plate-like actuating element according to an example implementation,

FIG. 5B shows a schematic bottom view of a plate-like actuating element according to a further example implementation,

FIGS. 6A-6E show schematic diagrams of an analog stick in a side view according to different example implementations, and

FIG. 7 shows a schematic diagram of an analog stick with a magnetic sensor in a side view according to an example implementation.

### DETAILED DESCRIPTION

Example implementations are described in more detail hereinbelow with reference to the figures, with elements that have the same or similar function being provided with the same reference signs.

Method steps depicted or described within the scope of the present disclosure may also be carried out in a sequence that differs from the depicted or described one. Moreover, method steps that relate to a particular feature of a device are able to be exchanged with this feature of the device, this also applying the other way round.

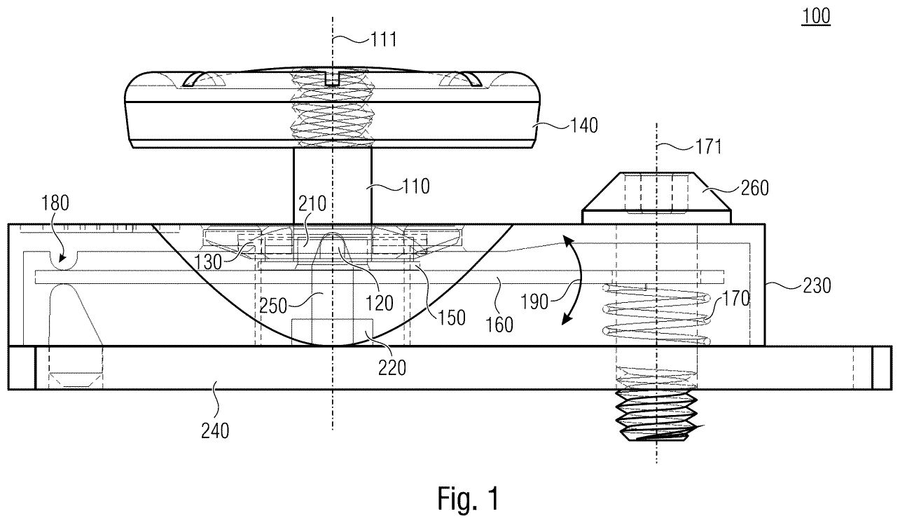

FIG. 1 shows a first conceivable implementation of an innovative analog stick 100. The analog stick 100 may, for example, be provided for use in a joystick or game controller. Other applications in which analog sticks can be used, such as equipment or machine controllers, are also encompassed.

FIG. 1 shows a partially transparent side view of the analog stick 100 including the associated mechanical system and sensor system. The analog stick 100 has an operating lever 110. The operating lever 110 is pivotably mounted using two rotation axles 120, 130 arranged orthogonally with respect to one another. The operating lever 110 can thus be moved in any desired manner forward, backward, left and right along a circular path.

The operating lever 110 can be configured in the form of an elongate cylinder. On a first axial end portion, the operating lever 110 can have an operating element 140 for moving the operating lever 110. For this purpose, the operating element 140 is fixedly connected to the operating lever 110, such that a movement of the operating element 140 is transmitted to the operating lever 110. The operating element 140 may, for example, be a disk-like top piece which is movable with a finger. As an alternative, the operating element 140 may also be a joystick which is operated with the whole hand, or a stick which can be operated with the fingers. On its opposite second axial end portion, the operating lever 110 can have a plate-like actuating element 150 which is also movable together with the operating lever 110.

A brace 160 is arranged below the operating lever 110. The brace 160 is located opposite the actuating element 150. The brace 160 may, for example, be configured in the form of an elongate, flat plate. The brace 160 is preferably rigid or flexurally resistant. The brace 160 can comprise metal or plastic.

The brace 160 can be rotatably mounted. For example, the brace 160 may be clamped on one side, as is shown by way of example in FIG. 1 based on the bearing 180. Using the bearing 180, the brace 160 can be rotationally deflected, as is schematically indicated based on the double arrow 190.

The brace 160 can be preloaded using a spring element 170. The spring element 170 may be a metallic helical spring, which can be configured in the form of a tension or compression spring. As an alternative thereto, the spring element 170 may be a plastics spring, for example composed of a soft elastically deformable rubber. It is also possible for multiple spring elements 170 to be provided, for example in the form of an array of helical springs.

The plate-like actuating element 150 is in contact with the brace 160. The plate-like actuating element 150 is also configured to transmit a deflection of the operating lever 110 to the brace 160, as a result of which the brace 160 is deflected counter to the spring force of the spring element 170. This means a pivoting movement of the operating lever 110 can be transformed into a rotational movement of the brace 160.

The brace 160 is also configured to restore the operating lever 110 to its zero position in a non-actuated state using the spring force of the spring element 170. The zero position is shown in FIG. 1. For this purpose, the spring element 170 pushes the brace 160 into its starting position, in which the brace 160 acts on the plate-like actuating element 150 in such a way that the actuating element 150 forces the operating lever 110 into its neutral starting position or zero position. In this case, the plate-like actuating element 150 preferably rests flatly on the brace 160.

The innovative concept presented herein provides for the spring element 170 and the operating lever 110 to be laterally spaced apart from one another, as seen in the extent direction of the brace 160. In other words, the spring element 170 is offset laterally with respect to the operating lever 110 or orthogonally with respect to the operating lever 110 in its zero position. As seen in a top view, a projection of the operating lever 110 and a projection of the spring element 170 would not intersect.

The spring element 170 is therefore no longer attached directly below the operating lever 110. As a result, installation space can be saved directly opposite or below the operating lever 110, and can be utilized in some other way. A few advantageous use examples are explained in more detail below.

According to the innovative concept disclosed herein, the spring element 170 and the operating lever 110 are spaced apart from one another in such a way that an imaginary extension of the operating lever 110 runs not through the spring element 170 but outwardly past the spring element 170 when the analog stick 100 is in its zero position.

In the zero position of the analog stick 100, the central axis 171 of the spring element 170 and the central axis 111 of the operating lever 110 run parallel to one another and are offset relative to one another or spaced apart from one another laterally (e.g., laterally or perpendicularly with respect to the central axes 111, 171). In this case, in the zero position of the analog stick 100, both the central axis 171 of the spring element 170 and the central axis 111 of the operating lever 110 each run perpendicular to the two rotation axles 120, 130 of the operating lever 110.

The operating lever 110 and the spring element 170 are thus arranged eccentrically. The lateral offset then results in additional installation space below the operating lever 110 that can be utilized for example for accommodating a sensor system for motion detection of the operating lever 110.

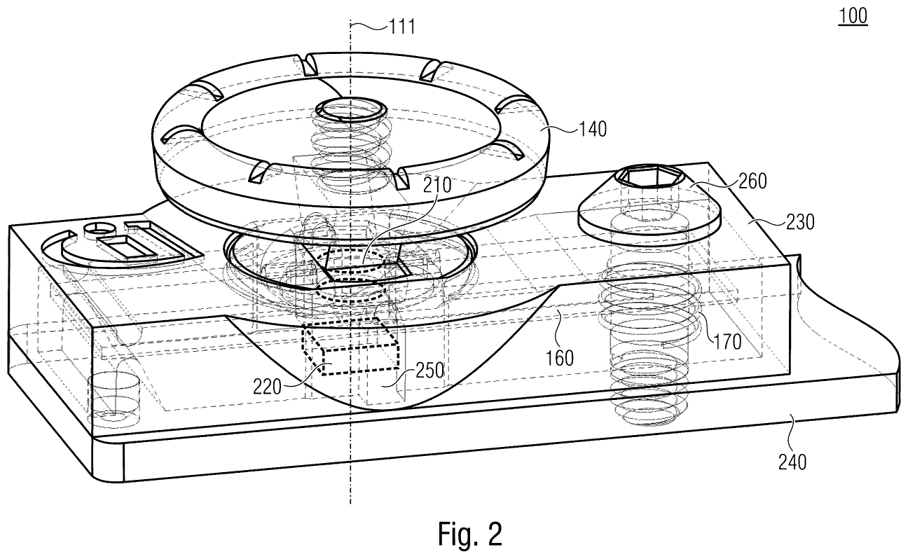

For example, a magnetic sensor can be used, which can highly precisely resolve the movement of the operating lever 110. As can be seen in FIG. 1 and in FIG. 2, it is for example possible for a magnet 210 to be arranged on the second axial end portion of the operating lever 110. The magnet 210 can be fixed on the end side of the operating lever 110, or be integrated into the operating lever 110. Integration into the operating lever 110 provides an additional installation space saving. In both cases, the operating lever 110 and the magnet 210 can be arranged concentrically about a common central axis 111.

A magnetic sensor 220 can be arranged oppositely from the second axial end portion of the operating lever 110, the magnetic sensor being configured to detect a movement of the magnet 210, and thus also a movement of the operating lever 110. The magnetic sensor 220 can thus be arranged directly below the operating lever 110. Since the spring element 170 is spaced apart laterally therefrom, the spring element 170 does not generate any magnetic interference fields which could impair the measurement.

The magnet 210 is preferably arranged on the operating lever 110 in such a way that a central axis of the magnet 210 runs through the magnetic sensor 220 both in the zero position and in a deflected position of the analog stick 100. This makes it possible to detect the orientation or position of the operating lever 110 over the complete movement range thereof.

The magnetic sensor 220 can be configured as a 3D sensor. Accordingly, the magnetic sensor 220 can detect a movement of the magnet 210 in the x, y and z direction. The magnetic sensor 220 can thus detect the rotational, tilting and pivoting movements of the operating lever 110. However, at the same time the 3D magnetic sensor 220 can also detect a pressing movement or vertical movement of the operating lever 110, as a result of which a pushbutton functionality can additionally be realized. A single magnetic sensor 220 can thus suffice to cover all the desired functionalities of the analog stick 100, for which three different components (two potentiometers and a pushbutton switch) are otherwise required in conventional analog sticks.

In the example implementation depicted here, the brace 160 is arranged between the magnet 210 and the magnetic sensor 220. It is advantageous for the brace 160 to consist of a non-magnetic material, such as copper, aluminum, brass, etc., in order to not impair the measurements of the magnetic sensor 220. Such an arrangement is space-saving and at the same time the magnetic sensor 220 delivers reliable and highly precise values.

As can be seen in FIGS. 1 and 2, the analog stick 100 can have a housing 230. The housing 230 in turn can be arranged on a substrate 240, such as a PCB (printed circuit board). All the components and elements described hitherto, with the exception of the operating lever 110 and the operating element 140, can be arranged or integrated in the housing 230. The operating lever 110 can extend through an opening in the housing 230 out of the housing 230, such that the operating element 140 is accessible from the outside.

The magnetic sensor 220 can be arranged on the substrate 240. Optionally, a bearing block 250 can be arranged on the substrate 240, the bearing block extending vertically upward (e.g., in the direction of the housing cover) from the substrate 240 and receiving the two rotation axles 120, 130. The bearing block 250 can have a slot-like opening through which the brace 160 extends.

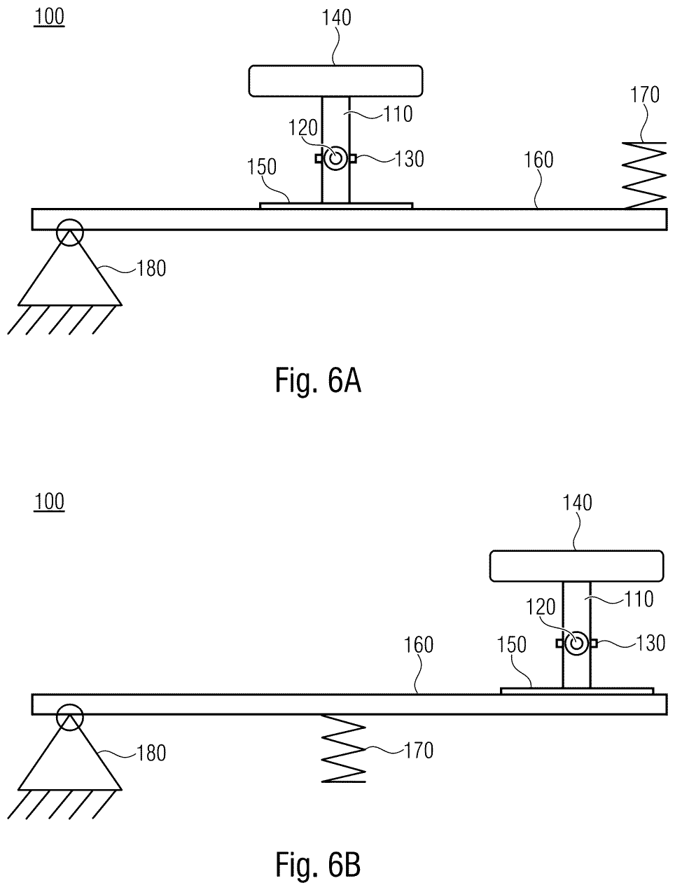

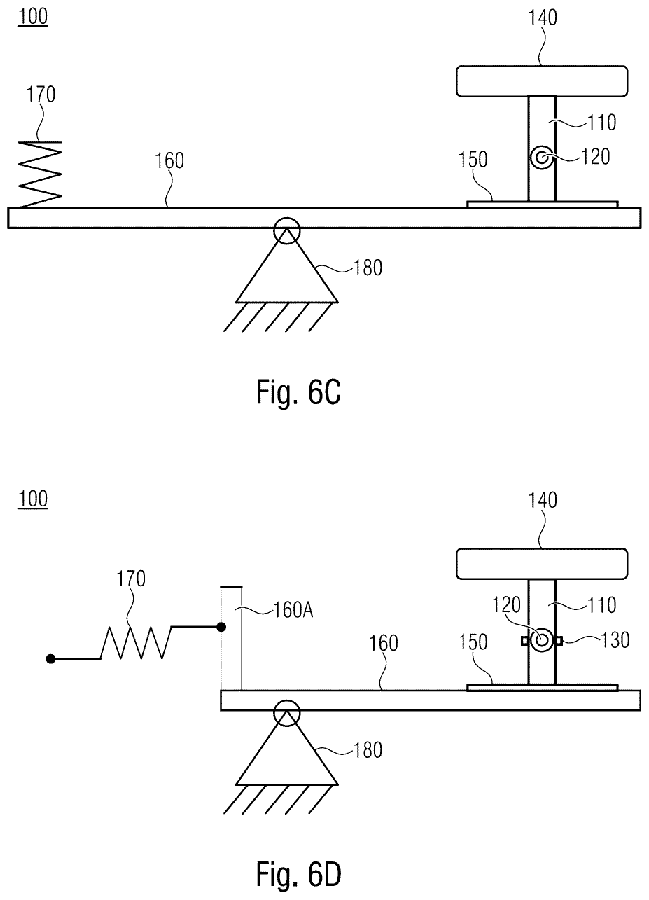

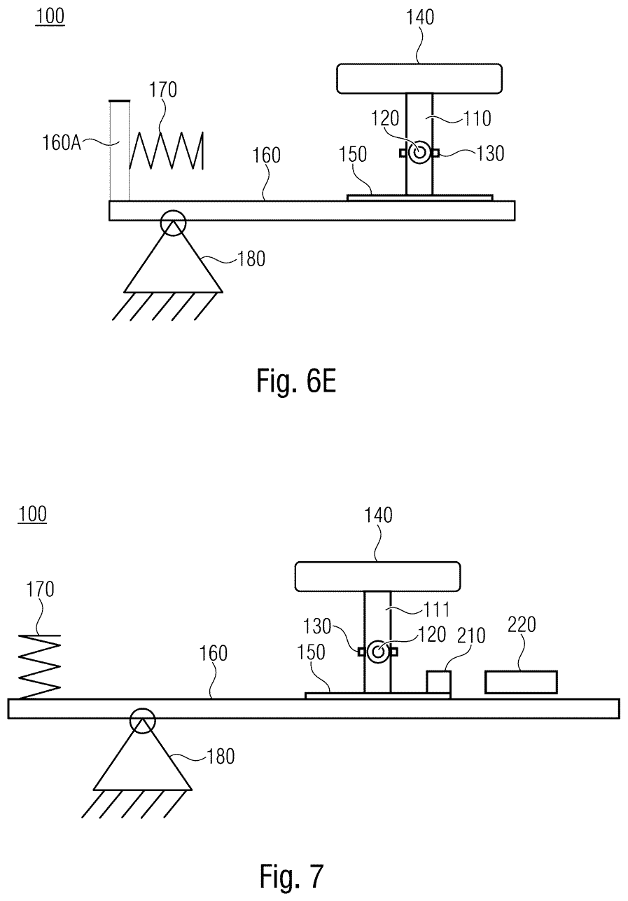

The bearing 180 in which the brace 160 is rotatably mounted can also be arranged on the substrate 240. In addition, the spring element 170 can optionally also be arranged on the substrate 240 and be supported on same. In the example implementation depicted in FIGS. 1 and 2, it is a compression spring. However, a tension spring would also be conceivable, which could, for example, be mounted on the housing cover. Various example implementations are explained in more detail below with reference to FIGS. 6A to 6E.

The spring element 170 can be fixed in position with the aid of a fastening means 260. This may, for example, be a screw which is passed perpendicularly through the spring element 170. For this purpose, the screw 260 can be introduced through an opening in the housing cover and be screwed on the opposite side in the substrate 240. The fastening means 260 can also extend through an opening in the brace 160. As a result, the brace 160 is secured against unintentional rotation or tilting.

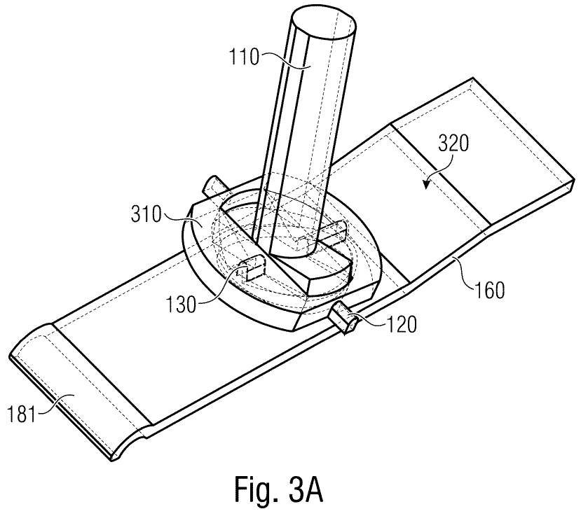

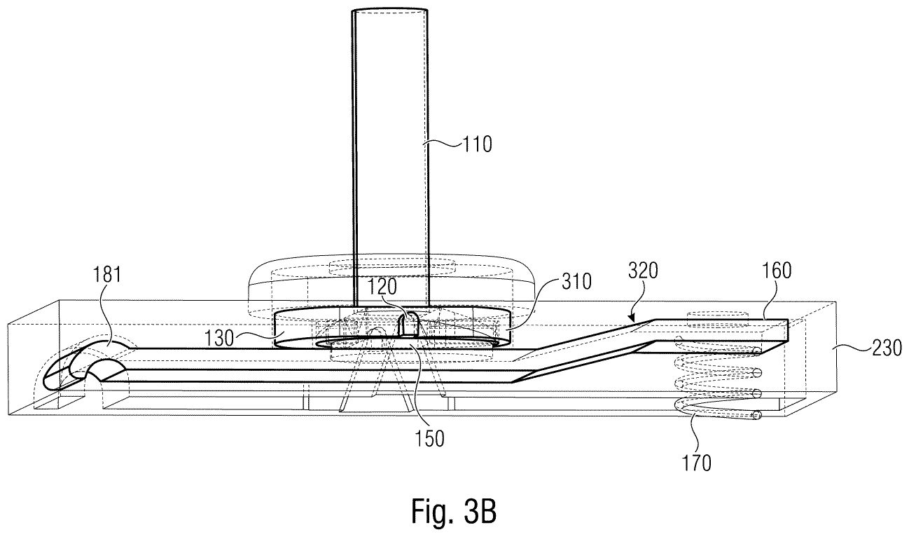

FIGS. 3A and 3B show detail views of the mounting of the operating lever 110 and the functional cooperation of the plate-like actuating element 150 with the brace 160. As already mentioned in the introduction, the operating lever 110 can be pivotably mounted using two rotation axles 120, 130 arranged orthogonally with respect to one another.

The operating lever 110 can, for example, have a first rotation axle 130 which is rotatably mounted in a bearing element 310. The bearing element 310 in turn can have a second rotation axle 120 which runs orthogonally with respect to the first rotation axle 130 and using which the bearing element 310, and thus the operating lever 110, is rotatably mounted in the above-described bearing block 250.

In the partially transparent side view depicted in FIG. 3B, the mounting 181 of the brace 160 can also be seen, using which the brace 160 is rotatably mounted in the bearing 180 (FIGS. 1 and 2). It can also be seen here that the brace 160 can have a kink 320 or a curvature, in order to generate an elevation under which the spring element 170 can be arranged in a space-saving manner. As an alternative thereto, the brace 160 may have a recess in which the spring element 170 can be arranged in a space-saving manner. This would be an option for example if the spring element 170 were to be configured in the form of a tension spring which is mounted on the housing cover.

The plate-like actuating element 150 can also be seen in FIG. 3B. The plate-like actuating element 150 can, for example, be arranged in a cutout in the bearing element 310. The plate-like actuating element 150 is also coupled in terms of movement to the operating lever 110, e.g., it moves with the operating lever 110.

As has already been explained above with reference to FIGS. 1 and 2, the brace 160 is preloaded using the spring element 170, such that the brace 160 forces the operating lever 110 into its zero position when not actuated. The plate-like actuating element 150 can rest flatly on the surface of the brace 160, as is shown by way of example in FIG. 3B.

If, however, the operating lever 110 is then moved, the plate-like actuating element 150 also moves and tilts or pivots accordingly. As a result, the flush abutment surface of the plate-like actuating element 150 present in the zero position turns into a single contact point, e.g., the plate-like actuating element 150 then no longer touches the brace 160 in a full-area manner, but rather only at a single contact point.

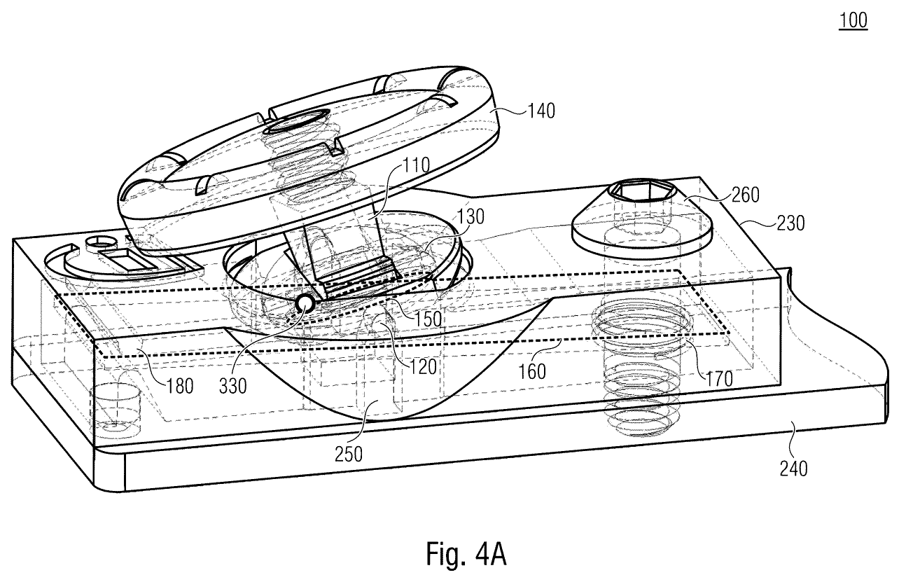

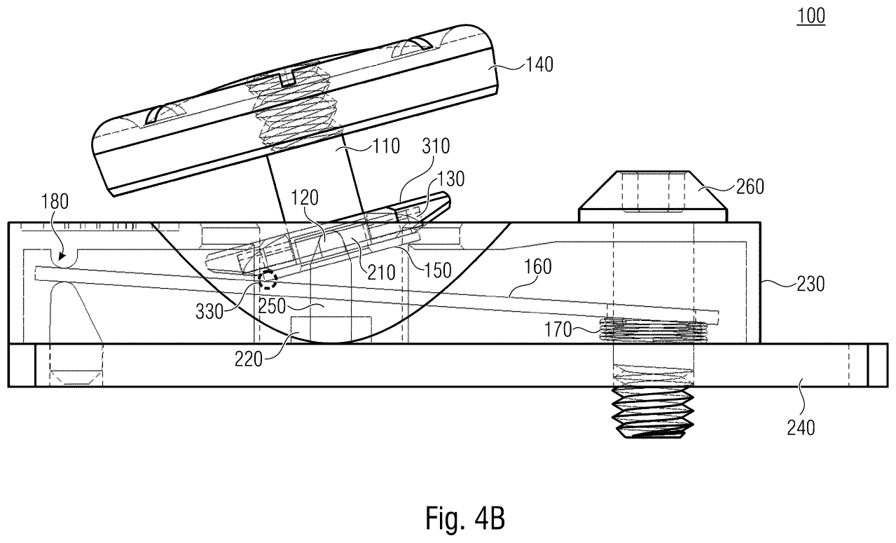

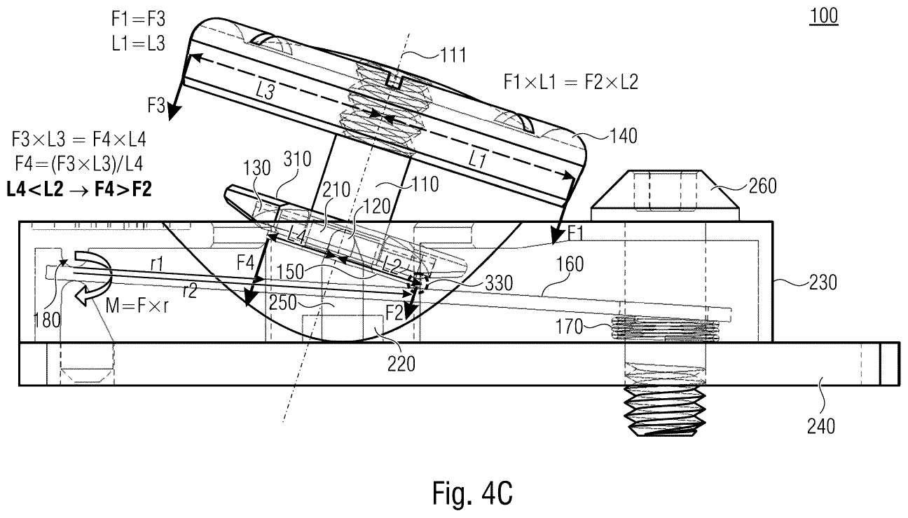

FIGS. 4A and 4B illustrate this based on the symbolically illustrated contact point 330. In the position shown here, the operating lever 110 is rotated both about the first rotation axle 120 and about the second rotation axle 130. As a result, the plate-like actuating element 150 tilts, such that the outer periphery thereof forms a single contact point 330 with the brace 160. At this contact point 330, the plate-like actuating element 150 exerts a deflection force on the brace 160, in order to deflect the brace 160 counter to the spring force of the spring element 170. This rotates the brace 160 about its bearing 180.

The contact point 330 varies with the position of the operating lever 110. This means that, depending on the position of the operating lever 110, the plate-like actuating element 150 comes into contact with the brace 160 in different brace regions or brace portions. However, as explained below, differently sized deflection forces are required in different brace portions in order to deflect the brace 160. This leads to non-uniform haptics when operating the analog stick 100, for which the innovative concept, however, provides a solution.

FIG. 4C first shows a further partially transparent side view of the analog stick 100 in a deflected state, wherein the force vectors F1, . . . , F4 depicted here and the length specifications L1, . . . , L4 should initially be disregarded. In FIG. 4C, the operating lever 110 is deflected in the opposite direction in comparison to FIG. 4B. Here, too, the plate-like actuating element 150 tilts during the movement of the operating lever 110, such that the outer periphery of the plate-like actuating element 150 is in contact with the surface of the brace 160 at exactly one contact point 330 and rotationally deflects the brace counter to the spring force of the spring element 170.

For the rotational deflection of the brace 160 about the bearing 180, a torque M is required. On account of the physical lever rule (M=F×r), the deflection force transmitted at the contact point 330 to the brace 160 and required to generate the torque M required for deflection of the brace 160 is greater the shorter the lever arm is, e.g., the shorter the distance r from the bearing 180 of the brace 160 is. In FIG. 4C, the lever arms or distances from the bearing 180 are labeled r1 and r2. That is to say that in order to deflect the brace 160, in the position of the operating lever 110 shown in FIG. 4B, on account of the shorter lever arm r1 a greater deflection force is required than in the position of the operating lever 110 shown in FIG. 4C.

In the position shown in FIG. 4C, the contact point 330 of the plate-like actuating element 150 is the distance r2 away from the bearing 180. By contrast, in the position shown in FIG. 4B, the contact point 330 of the plate-like actuating element 150 is a smaller distance r1 (r1<r2) away from the bearing 180. In order to then generate the same torque M for deflecting the brace 160, on account of the smaller lever r1, a greater deflection force is thus required at the contact point 330 the distance r1 away (FIG. 4B) than at the contact point 330 the distance r2 away (FIG. 4C). This means differently sized deflection forces are required in different brace regions or brace portions in order to deflect the brace 160.

However, this manifests for the user as non-uniform haptics, e.g., the haptics when actuating the operating lever 110 vary with the respective position of the operating lever 110. However, it is desired that the haptics of the operating lever 110 be the same in all the positions thereof. The innovative analog stick 100 presented herein provides a solution for this, specifically with a novel geometrical shaping of the plate-like actuating element 150.

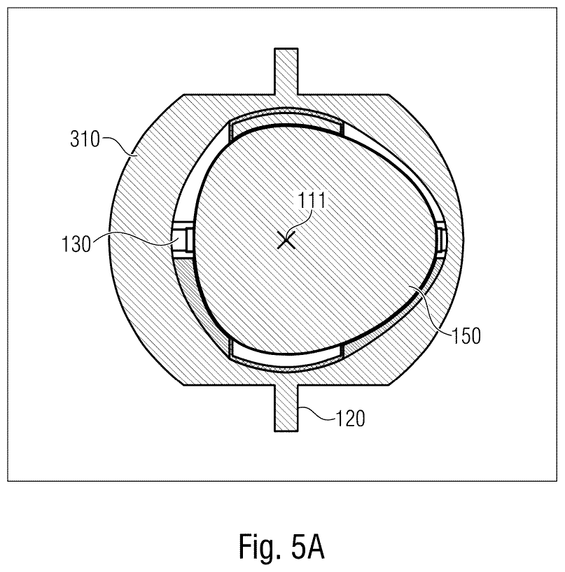

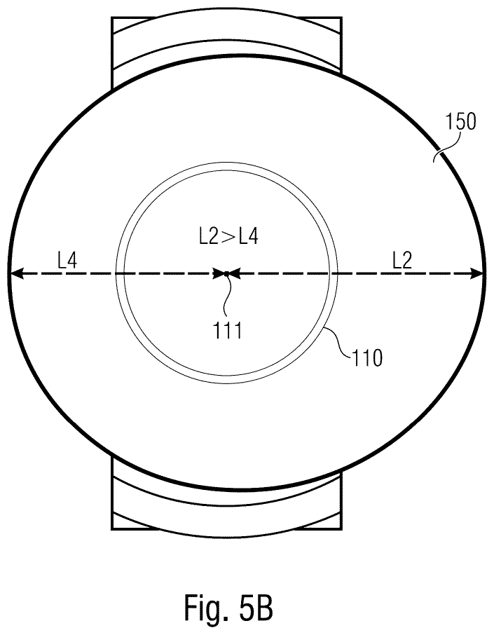

FIG. 5A shows a possible implementation of the plate-like actuating element 150, using which the above-described different deflection forces can be compensated, and therefore the haptics of the operating lever 110 are largely consistent for the user in all positions of the operating lever 110.

FIG. 5A shows a view of the bottom side of the plate-like actuating element 150, the bottom side facing toward the brace 160. The operating lever 110 (not visible here) is arranged on the opposite side. As can be seen, the plate-like actuating element 150 has an eccentric shape in relation to the central axis 111 of the operating lever 110. More specifically, the outer contour of the plate-like actuating element 150 has an eccentric shape in relation to the central axis 111.

FIG. 5B shows a further implementation of the plate-like actuating element 150. Here, too, the outer contour of the plate-like actuating element 150 has an eccentric shape with respect to the central axis 111 of the operating lever 110, which is depicted schematically here. The eccentric outer contour is not as strongly pronounced in FIG. 5B as in FIG. 5A. Nevertheless, it can be seen in both cases that the plate-like actuating element 150 in each case has substantially an egg shape.

FIG. 5B also depicts the radial distances L2, L4 of the outer contour of the plate-like actuating element 150. As can be seen, the outer contour of the plate-like actuating element 150 is a different distance away from the central axis 111 of the operating lever 110 at different locations. On the left-hand side visible in the image, the outer contour of the plate-like actuating element 150 has a first radial distance L4. On the opposite right-hand side visible in the image, the outer contour of the plate-like actuating element 150 has a different second radial distance L2. In this example, L2>L4.

As is explained in more detail later, the plate-like actuating element 150 is arranged on the operating lever 110 such that the outer contour (L4) located closer to the central axis 111 of the operating lever 110 points in the direction of the bearing 180 of the brace 160, whilst the outer contour (L2) of the plate-like actuating element 150 with a greater spacing is directed away from the bearing 180 of the brace 160.

As mentioned in the introduction, differently sized deflection forces are required in different brace regions or brace portions in order to deflect the brace 160 with one and the same torque M. This in turn is due to the different lever arms r1, r2. That is to say that in a brace portion which is positioned closer to the bearing 180 of the brace 160, a greater force is required for deflecting the brace 160 than in a brace portion which has a greater distance from (greater lever arm with respect to) the bearing 180 of the brace 160.

According to the innovative concept presented herein, the radial distance L2 between the outer contour of the plate-like actuating element 150 and the central axis 111 of the operating lever 110 is therefore greater in brace regions in which a lower deflection force is required for deflecting the brace 160 than in brace regions in which a relatively greater deflection force is required for deflecting the brace 160.

In relation to the pivot point or the bearing 180 of the brace 160, this means that that outer contour of the plate-like actuating element 150 which faces toward the bearing 180 of the brace 160 has a smaller distance L4 from the central axis 111 of the operating lever 110 than that outer contour (L2) of the plate-like actuating element 150 which faces away from the pivot point 180 of the brace 160.

In sum, it can be stated with respect to the geometrical shaping of the outer contour of the plate-like actuating element 150 that the outer contour is closer to the central axis 111 of the operating lever 110 the closer it is positioned to the bearing 180 of the brace 160, or the smaller the lever arm r1, r2 at the respective contact point 330. Conversely, this means that the outer contour is spaced further away from the central axis 111 of the operating lever 110 the further away it is positioned from the bearing 180 of the brace 160, or the greater the lever arm r1, r2 at the respective contact point 330.

An explanation of this will be given below with reference to FIG. 4C, the depicted force vectors F1, . . . , F4 and the radial distances L1, . . . , L4 now being taken into consideration here. It can first be seen that the user can exert an operating force F1, F3 on the operating element 140 in order to move the operating lever 110. This operating force F1, F3 is transmitted via the operating lever 110 to the plate-like actuating element 150. At the contact point 330, the plate-like actuating element 150 exerts a deflection force F2, F4, which is dependent on the operating force F1, F3, on the brace 160. The deflection force F2, F4 generates the above-mentioned torque in order to deflect the brace 160 counter to the spring force of the spring element 170.

As mentioned in the introduction, substantially identical haptics for the user are desired over the entire movement range of the operating lever 110. This can be achieved by virtue of the operating forces F1, F3 for moving the operating element 140 being substantially the same size in all positions of the operating lever. In FIG. 4C, this is symbolized in that F1=F3. A symmetrical configuration of the operating element 140 is assumed here, e.g., L1=L3.

The operating force F1, F3 exerted by the user on the operating element 140 is then transmitted via the operating lever 110 to the opposite plate-like actuating element 150. At its contact point 330, the plate-like actuating element 150 then exerts a deflection force F2, F4, which is dependent on the operating force F1, F3, on the brace 160. Here, too, the lever rule comes into effect again because the plate-like actuating element 150 has a smaller extent than the operating element 140, e.g., L4<L3 and L2<L1. Here, a transfer of force between the operating force F1, F3 and the deflection force F2, F4 thus takes place.

In the position of the operating lever 110 shown in FIG. 4C, the operating force F1 exerted on the operating element 140 is transmitted via the operating lever 110 to the plate-like actuating element 150 at the contact point 330 depicted here. At the contact point 330, the plate-like actuating element 150 then exerts a corresponding deflection force F2 on the brace 160. According to the force conservation law in lever deflections, the following applies: F1×L1=F2×L2.

When the operating lever 110 is brought to the opposite position (FIG. 4B), it behaves similarly, e.g., in the position of the operating lever 110 shown in FIG. 4B, the operating force F3 exerted on the operating element 140 is transmitted via the operating lever 110 to the plate-like actuating element 150. At the contact point 330, the plate-like actuating element 150 then exerts a corresponding deflection force F4 on the brace 160. According to the force conservation law in lever deflections, the following applies: F3×L3=F4×L4.

If resolution is then performed according to F4, the following applies: F4=(F3×L3)/L4. That is to say the shorter the lever L4 the greater the deflection force F4. The lever L4 corresponds here to the radial distance L4, described above with reference to FIG. 5B, of the outer contour of the plate-like actuating element 150 from the central axis 111 of the operating lever 110.

The same can then be done with the forces F1, F2. If resolution is then performed according to F2, the following applies: F2=(F1×L1)/L2. That is to say the longer the lever L2 the smaller the deflection force F2. The lever L2 corresponds here to the radial distance L2, described above with reference to FIG. 5B, of the outer contour of the plate-like actuating element 150 from the central axis 111 of the operating lever 110.

As can be seen in FIG. 4C, the radial distance L4 is smaller than the radial distance L2. Accordingly, the deflection force F4 is greater than the deflection force F2. The greater deflection force F4 can correspondingly be transmitted to the brace 160 in the brace portions in which the lever arm r is shorter (see r1), and the smaller deflection force F2 in turn can be transmitted to the brace 160 in the brace portions in which the lever arm r is longer (see r2). As a result, the brace 160 can be deflected with the same torque M in all lever positions. Accordingly, the operating forces F1, F3 required for this are also the same size for the operating of the operating element 140, leading to consistent haptics for the user.

According to the innovation, it is thus possible using the specific shaping of the plate-like actuating element 150 for differently sized deflection forces F2, F4 to be exerted on the brace 160 in different positions of the operating lever 110, whilst, by contrast, the operating forces F1, F3 required for actuating the operating element 140 are the same size in different lever positions.

The shaping of the plate-like actuating element 150 refers in particular to the outer contour thereof. The closer the outer contour of the plate-like actuating element 150 is to the pivot point 180 of the brace 160, the smaller the radial distance L4 from the central axis 111 of the operating lever 110 should be selected, since there a higher deflection force F4 must be applied in order to generate the torque required there for deflecting the brace 160.

The contact point 330, which is dependent on the position of the operating lever 110, thus defines a force engagement point of the deflection force F2, F4, exerted on the brace 160, for generating the torque M, in order to deflect the brace 160 counter to the spring force. However, as mentioned in the introduction, in order to generate the torque M, differently sized deflection forces F2, F4 are required in different brace portions. Accordingly, differently sized deflection forces F2, F4 are thus also required at different positions of the contact point 330 in order to generate the torque M respectively required there for deflecting the brace 160 counter to the spring force.

The innovative plate-like actuating element 150 presented herein has a geometrical shaping using which differently sized magnitudes of the deflection force F2, F4 can be exerted on the brace 160 at the different positions of the contact point 330, such that the operating force F1, F3 required for moving the operating lever 110 is the same size in different positions of the operating lever 110 in spite of the respective differently sized magnitudes of the deflection force F2, F4.

It is thus possible to use the innovative plate-like actuating element 150 to transmit different deflection forces F2, F4 to the brace 160 at different contact points 330, in order to generate in each case the same torque for deflecting the brace 160 in different brace regions. As a result, the operating forces F1, F3 required for moving the operating lever become the same size in all lever positions, such that haptics which are uniform in all lever positions are produced for the user.

In the implementations described hitherto, the brace 160 was rotatably mounted using a bearing 180, the spring element 170 being arranged on a side of the brace 160 on the opposite side from the bearing 180, and the operating lever 110 being positioned between the bearing 180 and the spring element 170. A compression spring was also used for preloading the brace 160.

FIGS. 6A to 6E below show further conceivable implementations in order to demonstrate possible arrangements of the bearing 180, of the spring element 170, of the brace 160 and of the operating lever 110. These different implementations can for example then come into effect if there are installation space limitations.

FIG. 6A shows an example implementation in which a tension spring is used as spring element 170 instead of the compression spring discussed hitherto. The tension spring 170 may, for example, be fastened to the inner side of the upper housing cover of the housing 230 (FIG. 1). The above-described functionality of the rest of the components of the innovative analog stick 100 is otherwise largely identical, for which reason reference is made to the above description in this regard.

FIG. 6B shows a further example implementation of an innovative analog stick 100. Here, too, the brace 160 is again rotatably mounted using the bearing 180. However, here the spring element 170 is positioned between the bearing 180 and the operating lever 110. The compression spring 170 depicted by way of example here can be replaced by an oppositely arranged tension spring. The above-described functionality of the rest of the components of the innovative analog stick 100 is otherwise largely identical, for which reason reference is made to the above description in this regard.

FIG. 6C shows a further example implementation of an innovative analog stick 100, the brace 160 being mounted in a rocker-like manner. Here, the brace 160 is again rotatably mounted using the bearing 180, but in this case the bearing 180 is positioned between the spring element 170 and the operating lever 110. The compression spring 170 depicted by way of example here can be replaced by an oppositely arranged tension spring. The above-described functionality of the rest of the components of the innovative analog stick 100 is otherwise largely identical, for which reason reference is made to the above description in this regard.

FIG. 6D shows a further example implementation of an innovative analog stick 100, the brace 160 being mounted in a rocker-like manner. Here, the brace 160 is again rotatably mounted using the bearing 180, and here the bearing 180 is also again positioned between the spring element 170 and the operating lever 110. Here, the brace 160 has an angled portion 160A which protrudes from the surface of the brace 160 at a certain angle. For example, the brace 160 may have a depicted L shape. The spring element 170 may be fastened to this angled portion 160A in order to preload the brace 160. For example, the spring element 170 may be configured in the form of a tension spring which can be fixed to an inner side of the housing 230 (FIG. 1). The above-described functionality of the rest of the components of the innovative analog stick 100 is otherwise largely identical, for which reason reference is made to the above description in this regard.

FIG. 6E shows a further example implementation of an innovative analog stick 100. However, in comparison to the implementation shown in FIG. 6D, here the spring element 170 is configured in the form of a compression spring which can engage on the angled portion 160A of the brace 160. Otherwise, this implementation is identical to FIG. 6D. The above-described functionality of the rest of the components of the innovative analog stick 100 is otherwise also largely identical, for which reason reference is made to the above description in this regard.

FIG. 7 shows a further example implementation of an innovative analog stick 100. Here, a magnet 210 is arranged on the plate-like actuating element 150, such that the magnet 210 is movable together with the operating lever 110. A magnetic sensor 220 is arranged laterally next to the plate-like actuating element 150 and is configured to detect a movement of the magnet 210, and thus also a movement of the operating lever 110. In this case, the magnet 210 and the magnetic sensor 220 are arranged in such a way that they face toward the same side or surface of the brace 160 (here: the top side of the brace 160).

The example implementation depicted in FIG. 7 is an alternative to the arrangements of the magnet 210 and the magnetic sensor 220 that are described above with reference to FIGS. 1 and 2. This implementation can enable a reduction in the vertical installation space.

The above-described example implementations are merely an illustration of the principles of the innovative concept described herein. It is to be understood that modifications and variations of the arrangements and details described herein will be obvious to others skilled in the art. For this reason, the concept described herein is intended to be limited merely by the scope of protection of the following patent claims rather than by the specific details which have been presented herein based on the description and the explanation of the example implementations.

Although some aspects have been described in connection with an device, it is to be understood that these aspects also constitute a description of the corresponding method, with the result that a block or a structural element of a device should also be understood to be a corresponding method step or a feature of a method step. Analogously thereto, aspects which have been described in connection with a method step or as a method step also constitute a description of a corresponding block or detail or feature of a corresponding device.

### ASPECTS

The following provides an overview of some Aspects of the present disclosure:
Aspect 1: An analog stick for a joystick or game controller, the analog stick comprising: an operating lever which is pivotably mounted using two rotation axles arranged orthogonally with respect to one another, the operating lever having, on a first axial end portion, an operating element for moving the operating lever, and the operating lever having, on an opposite second axial end portion, a plate-like actuating element which is movable together with the operating lever; and a brace preloaded using a spring element, the plate-like actuating element being in contact with the brace and being configured to transmit a deflection of the operating lever to the brace, as a result of which the brace is deflected counter to a spring force of the spring element, the brace being configured to restore the operating lever to its zero position in a non-actuated state using the spring force of the spring element, and the spring element and the operating lever being laterally spaced apart from one another, as seen in an extent direction of the brace.
Aspect 2: The analog stick as recited in Aspect 1, wherein: the spring element and the operating lever being spaced apart from one another in such a way that an imaginary extension of the operating lever runs not through the spring element but outwardly past the spring element when the analog stick is in its zero position.
Aspect 3: The analog stick as claimed in any of Aspects 1-2, wherein: a central axis of the spring element and a central axis of the operating lever run parallel to one another and are offset laterally relative to one another in the zero position of the analog stick.
Aspect 4: The analog stick as recited in Aspect 3, wherein: the central axis of the spring element and the central axis of the operating lever each running perpendicular to the two rotation axles of the operating lever in the zero position of the analog stick.
Aspect 5: The analog stick as claimed in any of Aspects 1-4, further comprising: a magnet being arranged on the second axial end portion of the operating lever and being movable together with the operating lever; and a magnetic sensor being arranged oppositely from the second axial end portion of the operating lever and being configured to detect a movement of the magnet, and thus also a movement of the operating lever.
Aspect 6: The analog stick as recited in Aspect 5, wherein: the magnet being integrated in the operating lever, and the operating lever and the magnet being arranged concentrically about a common central axis.
Aspect 7: The analog stick as recited in Aspect 5, wherein: a central axis of the magnet running through the magnetic sensor both in the zero position and in a deflected position of the analog stick.
Aspect 8: The analog stick as recited in Aspect 5, wherein: the brace being arranged between the magnet and the magnetic sensor.
Aspect 9: The analog stick as claimed in any of Aspects 1-8, further comprising: a magnet being arranged on the plate-like actuating element and being movable together with the operating lever; and a magnetic sensor being arranged laterally next to the plate-like actuating element and being configured to detect a movement of the magnet, and thus also a movement of the operating lever.
Aspect 10: The analog stick as recited in Aspect 9, wherein: the magnet and the magnetic sensor being arranged such that they face toward the same side of the brace.
Aspect 11: The analog stick as recited in Aspect 5, wherein: the magnetic sensor being configured as a three-dimensionally measuring magnetic field sensor configured to detect the movement of the operating lever in three spatial directions.
Aspect 12: The analog stick as claimed in any of Aspects 1-11, wherein: the brace being manufactured from a non-magnetic material.
Aspect 13: The analog stick as claimed in any of Aspects 1-12, wherein: the brace being rotatably mounted using a bearing, the spring element being arranged on a side of the brace on the opposite side from the bearing, and the operating lever being positioned between the bearing and the spring element.
Aspect 14: The analog stick as claimed in any of Aspects 1-13, wherein: the brace being rotatably mounted using a bearing, and the spring element being positioned between the bearing and the operating lever.
Aspect 15: The analog stick as claimed in any of Aspects 1-14, wherein: the brace being rotatably mounted using a bearing, and the bearing being positioned between the spring element and the operating lever.
Aspect 16: The analog stick as claimed in any of Aspects 1-15, wherein: the plate-like actuating element is configured to exert differently sized deflection forces on the brace in different positions of the operating lever, whilst, by contrast, operating forces required for actuating the operating element are the same size in different lever positions.
Aspect 17: The analog stick as claimed in any of Aspects 1-16, wherein: the operating lever being able to be moved by an exertion of an operating on the operating element, the brace running through under the operating lever, and the operating force being transmitted via the operating lever to the plate-like actuating element, and the plate-like actuating element being in contact with the brace via a contact point in a deflected position of the operating lever, and the plate-like actuating element exerting, at the contact point, a deflection force, which is dependent on the operating force on the brace, as a result of which a torque is generated which deflects the brace counter to the spring force of the spring element.
Aspect 18: The analog stick as recited in Aspect 17, wherein: the contact point, which is dependent on the position of the operating lever, defining a force engagement point of the deflection force exerted on the brace, for generating the torque, differently sized deflection forces being required at different positions of the contact point in order to generate the torque respectively required there for deflecting the brace counter to the spring force, and the plate-like actuating element having a geometrical shaping by means of which respective differently sized magnitudes of the deflection force are exerted on the brace at the different positions of the contact point, the operating force required for moving the operating lever being the same size in different positions of the operating lever in spite of the respective differently sized magnitudes of the deflection force.
Aspect 19: The analog stick as claimed in any of Aspects 1-18, wherein: the plate-like actuating element has an eccentric outer contour.
Aspect 20: The analog stick as claimed in any of Aspects 1-19, wherein: an outer contour of the plate-like actuating element has substantially an egg shape.
Aspect 21: The analog stick as claimed in any of Aspects 1-20, wherein: an outer contour of the plate-like actuating element being a different distance away from a central axis of the operating lever at different locations, and a radial distance between the outer contour of the plate-like actuating element and the central axis of the operating lever being greater in brace regions in which a lower deflection force is required for deflecting the brace than in brace regions in which a relatively greater deflection force is required for deflecting the brace.
Aspect 22: The analog stick as claimed in any of Aspects 1-21, wherein: an outer contour of the plate-like actuating element being a different distance away from a central axis of the operating lever at different locations, and that outer contour of the plate-like actuating element which faces toward a bearing of the brace having a smaller radial distance from the central axis of the operating lever than that outer contour of the plate-like actuating element which faces away from the pivot point of the brace.
Aspect 23: A system configured to perform one or more operations recited in one or more of Aspects 1-22.
Aspect 24: An apparatus comprising means for performing one or more operations recited in one or more of Aspects 1-22.

1. An analog stick for a joystick or game controller, the analog stick comprising:
an operating lever which is pivotably mounted fusing two rotation axles arranged orthogonally with respect to one another,
the operating lever having, on a first axial end portion, an operating element for moving the operating lever, and the operating lever having, on an opposite second axial end portion, a plate-like actuating element which is movable together with the operating lever; and
a brace preloaded using a spring element, the plate-like actuating element being in contact with the brace and being configured to transmit a deflection of the operating lever to the brace, as a result of which the brace is deflected counter to a spring force of the spring element,
the brace being configured to restore the operating lever to its zero position in a non-actuated state using the spring force of the spring element, and
the spring element and the operating lever being laterally spaced apart from one another, as seen in an extent direction of the brace.

2. The analog stick as claimed in claim 1, wherein:
the spring element and the operating lever being spaced apart from one another in such a way that an imaginary extension of the operating lever runs not through the spring element but outwardly past the spring element when the analog stick is in its zero position.

3. The analog stick as claimed in claim 1, wherein:
a central axis of the spring element and a central axis of the operating lever run parallel to one another and are offset laterally relative to one another in the zero position of the analog stick.

4. The analog stick as claimed in claim 3, wherein:
the central axis of the spring element and the central axis of the operating lever each running perpendicular to the two rotation axles of the operating lever in the zero position of the analog stick.

5. The analog stick as claimed in claim 1, further comprising:
a magnet being arranged on the second axial end portion of the operating lever and being movable together with the operating lever; and
a magnetic sensor being arranged oppositely from the second axial end portion of the operating lever and being configured to detect a movement of the magnet, and thus also a movement of the operating lever.

6. The analog stick as claimed in claim 5, wherein:
the magnet being integrated in the operating lever, and the operating lever and the magnet being arranged concentrically about a common central axis.

7. The analog stick as claimed in claim 5, wherein:
a central axis of the magnet running through the magnetic sensor both in the zero position and in a deflected position of the analog stick.

8. The analog stick as claimed in claim 5, wherein:
the brace being arranged between the magnet and the magnetic sensor.

9. The analog stick as claimed in claim 1, further comprising:
a magnet being arranged on the plate-like actuating element and being movable together with the operating lever; and
a magnetic sensor being arranged laterally next to the plate-like actuating element and being configured to detect a movement of the magnet, and thus also a movement of the operating lever.

10. The analog stick as claimed in claim 9, wherein:
the magnet and the magnetic sensor being arranged such that they face toward the same side of the brace.

11. The analog stick as claimed in claim 5, wherein:
the magnetic sensor being configured as a three-dimensionally measuring magnetic field sensor configured to detect the movement of the operating lever in three spatial directions.

12. The analog stick as claimed in claim 1, wherein:
the brace being manufactured from a non-magnetic material.

13. The analog stick as claimed in claim 1, wherein:
the brace being rotatably mounted using a bearing,
the spring element being arranged on a side of the brace on the opposite side from the bearing, and
the operating lever being positioned between the bearing and the spring element.

14. The analog stick as claimed in claim 1, wherein:
the brace being rotatably mounted using a bearing, and
the spring element being positioned between the bearing and the operating lever.

15. The analog stick as claimed in claim 1, wherein:
the brace being rotatably mounted using a bearing, and
the bearing being positioned between the spring element and the operating lever.

16. The analog stick as claimed in claim 1, wherein:
the plate-like actuating element is configured to exert differently sized deflection forces on the brace in different positions of the operating lever, whilst, by contrast, operating forces required for actuating the operating element are the same size in different lever positions.

17. The analog stick as claimed in claim 1, wherein:
the operating lever being able to be moved by an exertion of an operating on the operating element, the brace running through under the operating lever, and the operating force being transmitted via the operating lever to the plate-like actuating element, and
the plate-like actuating element being in contact with the brace via a contact point in a deflected position of the operating lever, and the plate-like actuating element exerting, at the contact point, a deflection force, which is dependent on the operating force on the brace, as a result of which a torque is generated which deflects the brace counter to the spring force of the spring element.

18. The analog stick as claimed in claim 17, wherein:
the contact point, which is dependent on the position of the operating lever, defining a force engagement point of the deflection force exerted on the brace, for generating the torque,
differently sized deflection forces being required at different positions of the contact point in order to generate the torque respectively required there for deflecting the brace counter to the spring force, and
the plate-like actuating element having a geometrical shaping by means of which respective differently sized magnitudes of the deflection force are exerted on the brace at the different positions of the contact point, the operating force required for moving the operating lever being the same size in different positions of the operating lever in spite of the respective differently sized magnitudes of the deflection force.

19. The analog stick as claimed in claim 1, wherein:
the plate-like actuating element has an eccentric outer contour.

20. The analog stick as claimed in claim 1, wherein:
an outer contour of the plate-like actuating element has substantially an egg shape.

21. The analog stick as claimed in claim 1, wherein:
an outer contour of the plate-like actuating element being a different distance away from a central axis of the operating lever at different locations, and
a radial distance between the outer contour of the plate-like actuating element and the central axis of the operating lever being greater in brace regions in which a lower deflection force is required for deflecting the brace than in brace regions in which a relatively greater deflection force is required for deflecting the brace.

22. The analog stick as claimed in claim 1, wherein:
an outer contour of the plate-like actuating element being a different distance away from a central axis of the operating lever at different locations, and
that outer contour of the plate-like actuating element which faces toward a bearing of the brace having a smaller radial distance from the central axis of the operating lever than that outer contour of the plate-like actuating element which faces away from the pivot point of the brace.
